(19) United States
(12) Patent Application Publication
(10) Pub. No.: US 2011/0128341 A1
(43) Pub. Date: Jun. 2, 2011

(54) Thermal printer

(76) Inventor: Masanori Takahashi, Chiba-shi (JP)

(21) Appl. No.: 12/927,304

(22) Filed: Nov. 10, 2010

(30) Foreign Application Priority Data
Nov. 30, 2009 (JP) 2009-272375

(51) Int. Cl. B41J 2/325

(52) U.S. Cl. 347/220

(57) ABSTRACT

Provided is a thermal printer in which positioning precision between a platen roller and a thermal head is enhanced, thereby being capable of positively arranging heating elements within a heating element allowable range. A positioning mechanism (38) includes: a through-hole (40) which allows a head support member (23) to be movable with respect to a detachable frame (21); a regulating surface (44a) formed in the head support member (23), an elastic member (42) for urging the head support member (23) so that the regulating surface (44a) is abutted to a bearing (18) of the platen roller (6); and a guide portion (44b), which is formed in the head support member (23), for guiding the head support member (23) by moving the head support member along the through-hole (40) in association with a mounting operation of a cover unit (4) while sliding with the bearing (18) so that the regulating surface (44a) abuts the bearing (18), and the regulating surface (44a) is formed in a flat surface, and a normal line direction of the regulating surface (44a) coincides with a direction perpendicular to an axial direction of the platen roller (6) within a plane which is parallel with a head surface 19a of a thermal head (19).

### BACKGROUND OF THE INVENTION

1. Field of the Invention

The present invention relates to a thermal printer which performs printing various kinds of information on recording paper pulled out from roll paper.

2. Description of the Related Art

The thermal printer is a printer having such a structure that a particular recording paper (heat-sensitive paper), which develops color by being applied with heat, is sandwiched between a platen roller and a thermal head, and while the recording paper is being fed through rotation of the platen roller, a printing surface (heat-sensitive surface) of the recording paper is heated by a heating element of the thermal head to be developed color, thereby performing printing. As this type of the thermal printer, for example, there is known a head-open type thermal printer, which is incorporated into a cash resister or the like to be used for printing a receipt, etc. (for example, refer to Japanese Patent Application Laid-open No. 2000-318260).

This type of the thermal printer has such a structure that the platen roller head is provided on a chassis side, into which the recording paper wound into a roll is received, and the thermal head is provided on a side of a cover, which allows an opening portion of the chassis to be openable and closable. With this structure, under a state in which the printing surface is faced upward, and also under a state in which information printed on the printing surface is faced normal to a guest, the recording paper is delivered. Therefore, the clerk may hand over the recording paper to the guest without changing a direction of the recording paper, thereby being capable of performing a cash register operation smoothly.

Here, a detailed description is made of a head-open type thermal printer with reference to the drawings.

As illustrated in FIG. 19, a conventional thermal printer 100 includes: a main body unit 110 including a main body frame 111, which is fixed onto a side of a chassis (not shown), into which the recording paper wound into a roll is received; a cover unit 120 including a cover frame 121, which is fixed onto a side of cover (not shown), which allows an opening portion of the chassis to be openable and closable; a shaft 109, which is fixed to the main body frame 111, for rotatably supporting the cover unit 120 with respect to the main body unit 110; and a lock mechanism 107 for detachably assembling the cover frame 121 with respect to the main body frame 111.

First, the main body unit 110 includes a platen roller 104 rotatably supported with respect to the main body frame 111. On the other hand, the cover unit 120 includes: a thermal head 102 including a multiple number of heating elements 101 arrayed in a line; a head support member 103, which supports the thermal head 102, and is rotatably supported with respect to the above-mentioned shaft 109; and an elastic member 105 which urge the head support member 103 so that the thermal head 102 is brought into press-contact with the platen roller 104.

As thus constructed, by using the lock mechanism 107, the cover frame 121 may easily be mounted to the main body frame 111, and by releasing the locking with the lock mechanism 107, the cover frame 121 may easily be removed from the main body frame 111.

Further, the head support member 103 is configured to rotate about the shaft 109 so as to be brought into press-contact with the platen roller 104 by being urged by the elastic member 105. Therefore, designing is performed so that, when the cover frame 121 was mounted to the main body frame 111, printing may be performed while reliably sandwiching the recording paper P between the platen roller 104 and the thermal head 102.

By the way, in order to carry out satisfactory printing onto the recording paper P, as illustrated in FIG. 20, the position of the heating element 101 of the thermal head 102 with respect to the platen roller 104 needs to fall within an allowable range (allowable range L1 of heating element). In a case where the heating element 101 does not exist within the allowable range L1 of the heating element, there is a fear in that heat of the heating element 101 may not sufficiently transmit to the recording paper P, resulting in occurring a problem of lowering a printing quality, such as being not able to obtain a proper printing density.

Here, the allowable range L1 of the heating element is a range which is obtained by subtracting a predetermined margin M from a nip width L2. The nip width L2 is mainly determined by a contact range of the platen roller 104 and the thermal head 102. A center of the nip width L2, in general, does not match in many cases with a contact reference point N between the platen roller 104 and the thermal head 102 (point in a head surface 102a at which a distance to a center O1 of the platen roller 104 becomes shortest). This is because, due to rotation of the platen roller 104 and depending on a surface shape of the thermal head 102 (head surface 102a), deformation of the platen roller 104 becomes nonuniform between rotation upstream and downstream. Further, the margin M is set so as to absorb an error caused by dimensional fluctuations of parts.

Accordingly, the center of the allowable range L1 of the heating element is generally also offset to the rotation upstream side of the platen roller 104 than the contact reference point N. Note that, the center of the allowable range L1 of the heating element is set as an ideal target point of the heating element 101. In this case, a displacement amount between the target position and the contact reference point N is referred to as an offset amount L3.

Then, in order to carry out the printing with respect to the recording paper P with a satisfactory printing quality, it is necessary that the position of the heating element 101 be set so as to fall within the allowable range L1 of the heating element.

By the way, although described in the above as the nip width L2 is determined mainly based on the contact range between the platen roller 104 and the thermal head 102, in addition, the nip width L2 may change depending on properties such as a stiffness and thickness of the recording paper P to be used, and respective conditions, such as conveying path of the recording paper P. Accordingly, even the allowable range L1 of the heating element may similarly change depending on the above-mentioned respective conditions.

For example, assuming that the nip width of a thick recording paper P is L2 as illustrated in FIG. 20, in a case of a thin recording paper P which is likely to familiar with an outer peripheral surface of the platen roller 104, the nip width become larger than the width L2. Accordingly, the allowable range L1 of the heating element may naturally change, too.

Like this, the allowable range L1 of the heating element may differ depending on the recording paper P to be used, and hence in order to cope with all the kinds of the recording paper P, it is required to position the heating element 101 within a range at which respective allowable ranges L1 of the heating elements are overlapped. Accordingly, as the kinds of the recording paper P to be used is increased, the allowable range L1 of the heating element which may cope with all the recording paper P suffers a limitation to be shortened. Therefore, there arises a necessity to position the heating element 101 with high precision so as to fall within the range. Therefore, there is required a high positioning precision of the heating element 101 with respect to the platen roller 104.

By the way, in order to make easier to respond to those requirements, it is conceivable to increase a contact pressure (platen pressure) between the platen roller 104 and the thermal head 102 to enlarge the nip width L2, thereby enlarging the allowable range L1 of the heating element itself.

However, if the contact pressure increases, it leads to an increase of a motor load of a motor for driving the platen roller 104. Particularly, in recent years, along with downsizing of an apparatus, downsizing of the motor for driving the platen roller 104 is also advancing. Accordingly, it is a current state that the motor has no such allowance in its torque that the increase of the contact pressure necessary for securing a sufficient nip width L2 may be increased.

Accordingly, it was hard to enlarge, while achieving the downsizing of the apparatus, simultaneously, the allowable range L1 of the heating element itself.

To this end, conventionally, as means for positioning the heating element 101 with respect to the platen roller 104 with high precision as much as possible, it has been conducted to paste the thermal head 102 with respect to the head support member 103 with precision.

Specifically, as illustrated in FIG. 19, first, there is formed, at an end portion of the head support member 103, an abutting portion 108 which serves as a positioning surface between the thermal head 102 and the head support member 103. Then, when the thermal head 102 is pasted onto a pasting surface of the head support member 103, the pasting is carried out under a state in which an end surface 102b of the thermal head 102 is positioned to the abutting portion 108. With this structure, the thermal head 102 may be pasted onto the head support member 103 with precision using an inexpensive jig, which leads to high precision positioning of the heating element 101 with respect to the platen roller 104.

However, within a tendency of achieving downsizing in recent years, positioning precision of the heating element 101 with respect to the platen roller 104 becomes insufficient by the conventional method.

About this point, detailed description is made as follows.

First, it is thought that the following positioning precisions mainly influence against the positioning precision between the platen roller 104 and the heating element 101 (refer to FIG. 19).

(1) Distance D1 between a center axis O1 of the platen roller 104 and a rotation center O2 of the head support member 103.

(2) Distance D2 in a normal direction of a pasting surface 103a (thickness direction of the head support member 103) from the pasting surface 103a of the thermal head 102 to the rotation center O2 of in the head support member 103.

(3) Distance D3 from the rotation center O2 of the head support member 103 to the abutting portion 108 of the head support member 103.

(4) Distance D4 from the end surface 102b of the thermal head 102 to the heating element 101.

(5) Pasting tolerance of the thermal head 102 when pasting the thermal head 102 to the head support member 103 (distance between the abutting portion 108 and the end surface 102b of the thermal head 102).

Among the above-mentioned conditions, the conditions (3) to (5) depend on the positioning precision when the thermal head 102 is pasted onto the head support member 103. In particular, when the thermal head 102 is pasted to the head support member 103, although it leads to an increase of a facility cost, by directly controlling the position of the heating element 101 using an image recognition device, or the like based on the distance to the rotation center O2, the tolerance may further be reduced.

However, even if the increase of the facility cost is accepted to reduce the tolerances of the conditions (3) to (5), there are large tolerance influences generated in the conditions (1) and (2). As a result, there was a case where it was difficult to position the heating element 101 with respect to the platen roller 104 with a required precision.

In short, the head support member 103 is always urged by the elastic member 105, and is adapted to rotate about the shaft 109 as a center. With this structure, when the cover frame 121 is assembled to the main body frame 111 by the lock mechanism 107, the platen roller 104 is adapted so as to be brought into contact with the thermal head 102 by an appropriate contact pressure. In this case, a mounting position of the heating element 101 to the platen roller 104 is determined at its designing stage. Specifically, in the conventional thermal printer 100, the mounting position of the platen roller 104 (namely, above-mentioned distance D1) and the position of the heating element 101 are determined based on the shaft 109 which serves as the rotation center O2 of the head support member 103. The above-mentioned conditions (3) to (5) are all established on the premise described above.

Nevertheless, when the cover frame 121 is mounted to the main body frame 111, there was a case where, due to the part-dimension precisions of the main body unit 110 and the cover unit 120, a fixing precision between the main body frame 111 and the cover frame 121, or the like, the position of the light emitting, element 101 with respect to the platen roller 104 is slightly displaced from a position determined at its designing stage (distance D1 is changed). Even in such case, as described above, the head support member 103 rotates about the shaft 109 as a center by being urged by the elastic member 105, and hence there is no difference in that the platen roller 104 and the thermal head 102 are brought into contact with each other by an appropriate contact pressure. However, an inclination angle of the head support member 103 varies.

In other words, than a state illustrated in FIG. 19, the head support member 103 may tilt forward as illustrated in FIG. 21, or may tilt backward as illustrated in FIG. 22. Besides, in a case where the position of the lighting element 101 is displaced in parallel with the head surface 102a with respect to the position of the platen roller 104, without the head support member 103 from tilting, the position of the heating element 101 is displaced from the center of the allowable range L1 of the heating element.

In such case, even if the thermal head 102 is positioned accurately with respect to the head support member 103, the heating element 101 can not be positioned accurately with respect to the platen roller 104. As a result, there is a fear in that the heating element 101 may be arranged outside the allowable range L1 of the heating element.

In addition, even in a case where if the platen roller 104 is accurately mounted with respect to the main body frame 110, and there is no change in distance D1 described above, in a case where the above-mentioned distance D2 is changed due to the dimension precision of parts of the head support member 103, the tilting angle of the head support member 103 still changes.

### SUMMARY OF THE INVENTION

Therefore, the present invention has been made in view of the above-mentioned circumstances, and has an object to provide a thermal printer in which a positioning precision between a platen roller and a thermal head is enhanced, thereby being capable of positively arranging and providing a heating element within a heating element allowable range.

In order to solve the above-mentioned problems and to achieve the object described above, according to the present invention, there is provided a thermal printer, including:

a main body unit including a platen roller for performing paper feeding of recording paper;

a detachable unit detachably provided with respect to the main body unit; and

a lock mechanism for locking the main body unit and the detachable unit;
the detachable unit including:
   a detachable frame;
   a thermal head in which heating elements which perform printing on the recording paper are arranged on a head surface which is disposed in parallel with an axial direction of the platen roller when the detachable unit is mounted;
   a head support member onto which the thermal head is pasted and fixed, and is rotatably supported about a rotation shaft provided to the detachable frame;
   first urging means for urging the thermal head so as to be brought into pressure contact with the platen roller through intermediation of the head support member; and
   a positioning mechanism which performs positioning of the thermal head with respect to the platen roller,
in which the positioning mechanism includes:
   a guide hole which allows the head support member to be movable with respect to the detachable frame along a first direction which is orthogonal to an axial direction of the platen roller within a plane which is parallel to the head surface of the thermal head;
   a regulating portion, which is formed in the head support member, serving as a positioning reference portion at a time of positioning and fixing the thermal head to the head support member, and positioning, when the platen roller is mounted, positions of the heating elements with respect to the platen roller through abutment of the platen roller to the regulating portion;
   second urging means for urging the head support member along the first direction so that the regulating portion is abutted to the platen roller; and
   a guide portion, which is formed in the head support member, for guiding the head support member by moving the head support member along the guide hole in association with a mounting operation of the detachable unit while sliding with the platen roller so that the regulating portion abuts the platen roller, and

in which the regulating portion is formed in a flat surface, and a normal line direction of the flat surface coincides with the first direction.

According to the structure, there is employed a structure in which a removal unit and the main body unit are locked by the lock mechanism when being used, and hence the recording paper may be sandwiched between the platen roller and the thermal head. As a result, printing onto the recording paper may be performed while performing paper feeding by the platen roller. Further, by releasing the lock of the lock mechanism, the detachable unit may be detached from the main body unit.

Besides, when the detachable unit approaches to the main body unit at the time of mounting the detachable unit, first, the guide portion of the head support member is brought into contact with the platen roller. Then, as the guide portion slides on the platen roller in association with the mounting operation of the detachable unit, the head support member moves along with the guide portion, and the head support member is guided so that the regulating portion abuts on the platen roller. With this operation, the regulating portion of the head support member abuts on the platen roller. More specifically, the bearing of the platen roller abuts on the regulating portion. At this time, the head support member is urged by the second urging means along the first direction, and hence after the contact of the platen roller and the regulating portion, the mounting operation may be performed under a contacting state without the platen roller being spaced apart from the regulating portion. Then, the mounting operation of the detachable unit is further advanced, the platen roller and the head support member are brought into contact with each other. At this time, the thermal head is urged by the first urging means through the intermediation of the head support member, the head surface of the thermal head is brought into press contact with the platen roller.

Like this, by the first urging means, the head surface of the thermal head is brought into press contact with the platen roller, and by the second urging means, the regulating portion abuts on the platen roller. As a result, a relative position of the thermal head with respect to the platen roller is regulated. At this time, the regulating portion is a flat surface, which is formed so that the normal direction coincides with the first direction. Further, the thermal head is positioned and fixed with respect to the regulating portion at a position at which a satisfactory printing quality may be obtained when the bearing of the platen roller abuts on the regulating plate. As a result, the relative position between the platen roller and the heating elements of the thermal head may be positioned with high precision so that a satisfactory printing quality is obtained. Besides, as described above, as the head support member is urged by the second urging means along the first direction, under a state in which the platen roller and the regulating portion are brought into contact with each other, and in addition, while maintaining such positional relationship between an outer peripheral surface of the platen roller and the heating elements, which is the positional relationship with which a satisfactory printing quality is obtained, the mounting operations thereafter may be carried out.

After that, the detachable frame is locked with the main body frame by the lock mechanism, and hence the setting of the thermal head to the main body frame is completed.

When the detachable unit is to be mounted in the main body frame, even if an installation position of the thermal head in the detachable unit is slightly displaced from a position determined at a designing stage, and even if the tilting angle of the head support member is changed from a predetermined position due to generation of an error in the thickness direction of the head pasting surface, different from the conventional one, the positional relationship between the platen roller and the heating elements may be kept unchanged from the above-mentioned positional relationship.

In other words, the head surface of the thermal head is brought into pressure contact with the platen roller by the first urging means, and the regulating portion abuts on the platen roller by the second urging means. As a result, while keeping a state in which a relative position among the platen roller, the regulating portion, and the thermal head falls within the heating element allowable range so that a satisfactory printing quality may be obtained, the positioning of the platen roller and the heating elements of the thermal head may be positively carried out.

Further, the guide hole is a long hole, which is formed in the head support member, having a length direction as the first direction, and the rotation shaft is inserted and passed through the long hole.

According to the structure, as the head support member conducts a slide movement along the first direction, there is no need to provide a separate moving mechanism. Owing to this, the structure may be simplified, and also the reduction of the manufacturing cost may be achieved.

According to the present invention, the position between the platen roller and the thermal head is determined with the regulating portion being reference. As a result, the influences of the conditions (1) and (2), which are conventionally identified as problems, and become large tolerance factors, may be eliminated, and further, in the positional relationship between the platen roller and the thermal head, the heating element may be positively positioned within the heating element allowable range. Owing to this, even in a case where a plurality of kinds of the recording paper having different thicknesses and stiffnesses are used, the heating element may be disposed within the heating element with high precision, thereby being capable of printing with a satisfactory printing quality.

Further, as described above, the guide portion, which guides the regulating portion so as to abut on the platen roller, is formed in the head support member, and hence, the head support member may be moved smoothly along the guide portion in the mounting operation. As a result, when the regulating portion and the platen roller are abutted on each other, the mounting operation of the detachable unit is free from being interrupted, thereby being capable of quickly mounting the detachable unit to the main body unit.

### BRIEF DESCRIPTION OF THE DRAWINGS

In the accompanying drawings:

FIG. 1 is an external perspective view of a thermal printer according to the present invention, for illustrating a close state of a cover;

FIG. 2 is an external perspective view of the thermal printer according to the present invention, for illustrating an open state of the cover;

FIG. 3 is a side view of the thermal printer according to the present invention, for illustrating the close state of the cover;

FIG. 4 is a sectional view taken along the line A-A of FIG. 1;

FIG. 5 is a sectional view taken along the line B-B of FIG. 1;

FIG. 6 is a plan view of a pasting jig;

FIG. 7 is a side view of the pasting jig;

FIG. 8 is a diagram illustrating a closing operation of the cover;

FIG. 9 is a diagram illustrating the closing operation of the cover;

FIG. 10 is a diagram illustrating the closing operation of the cover;

FIG. 11 is a diagram illustrating the closing operation of the cover;

FIG. 12 is a diagram illustrating the closing operation of the cover;

FIG. 13 is a diagram illustrating the closing operation of the cover;

FIG. 14 is a diagram illustrating the closing operation of the cover;

FIG. 15 is a diagram illustrating the closing operation of the cover;

FIG. 16 is a diagram illustrating the closing operation of the cover;

FIG. 17 is a diagram illustrating a state in which the head support member is tilted forward to be brought into contact with the platen roller;

FIG. 18 is a diagram illustrating a state in which the head support member is tilted backward to be brought into contact with the platen roller;

FIG. 19 is a side view of a conventional thermal printer;

FIG. 20 is a diagram illustrating a positional relationship between the platen roller and the heating element;

FIG. 21 is a diagram illustrating a state in which the head support member is tilted forward to be brought into contact with the platen roller in the conventional thermal printer; and

FIG. 22 is a diagram illustrating a state in which the head support member is tilted backward to be brought into contact with the platen roller in the conventional thermal printer.

### DETAILED DESCRIPTION OF THE PREFERRED EMBODIMENTS

Hereinafter, embodiments of the present invention are described with reference to the drawings. In the following description, description is made of a head-open type thermal printer having such a structure that, a main body unit, to which a platen roller is mounted, is provided to a chassis side into which recording paper wound into a roll is received, and a cover unit, onto which a thermal head is mounted, is provided to a cover side, which allows an opening portion of the chassis to be openable and closable.

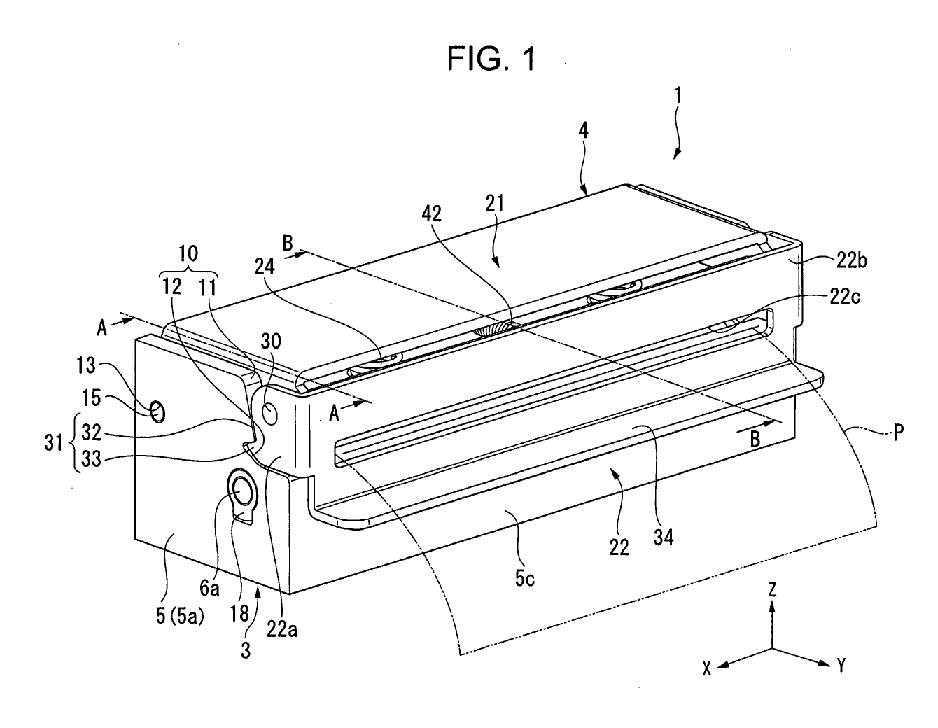

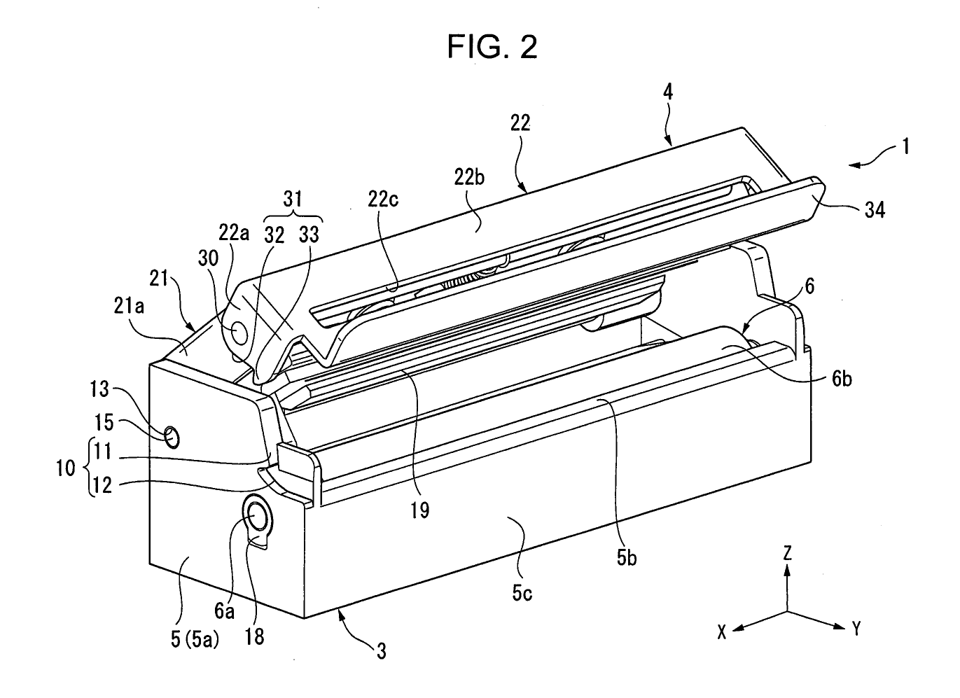

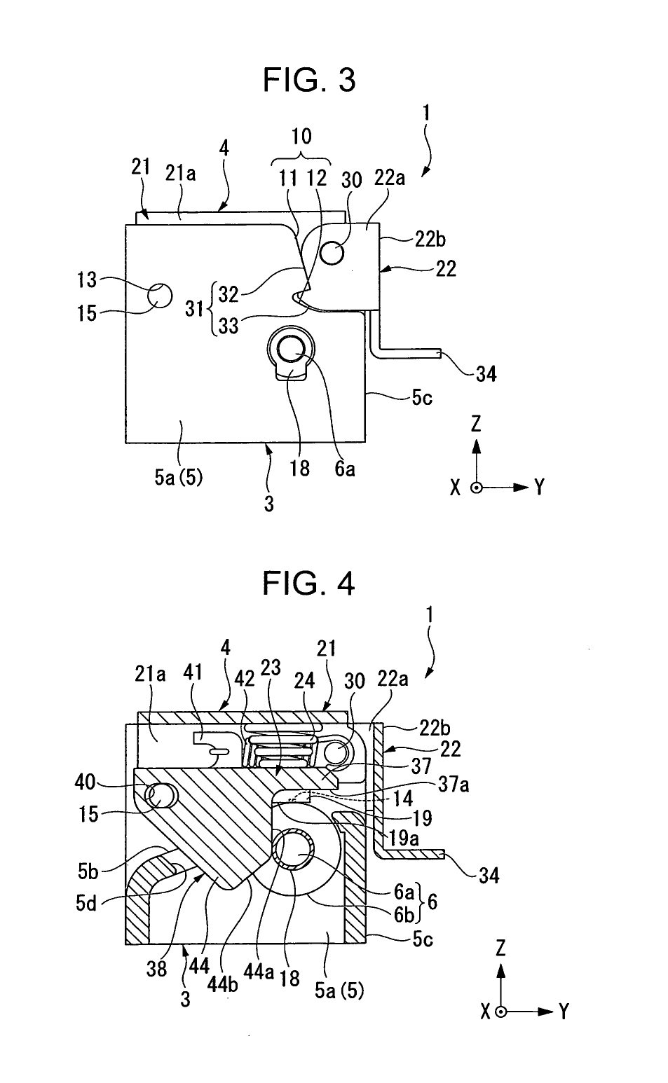

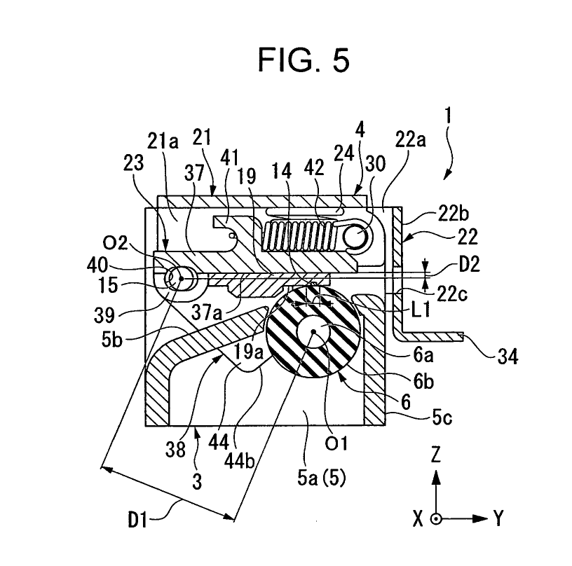

FIG. 1 and FIG. 2 are perspective views of a thermal printer according to the present invention, in which FIG. 1 illustrates a mounting state of the cover unit, and FIG. 2 illustrates a non-mounting state of the cover unit. Further, FIG. 3 is a side view of the thermal printer for illustrating the mounting state of the cover unit, FIG. 4 is a sectional view taken along the line A-A of FIG. 1, and FIG. 5 is a sectional view taken along the line B-B of FIG. 1. It should be noted that, in the figure, the chassis to which the thermal printer is assembled, the cover, and the like are omitted. Further, in the following description, at a time of mounting a cover unit 4 described later, a direction which coincides with an axial direction of the platen roller 6 is represented by an X-direction, within a plane which is parallel to the head surface 19a of a thermal head 19 provided in parallel with the X-direction, a direction orthogonal to the axial direction (X-direction) of the platen roller 6, is represented by a Y-direction (first direction), and a direction orthogonal to the head surface 19a is represented by a Z-direction.

As illustrated in FIG. 1 to FIG. 5, the thermal printer 1 according to this embodiment is a head-open type thermal printer 1, which is incorporated into a cash resister, or the like to perform a receipt printing on a recording paper P (refer to FIG. 1) pulled out from roll paper (not shown). Specifically, the thermal printer 1 includes a main body unit 3 and a cover unit (detachable unit) 4 detachably assembled to the main body unit 3.

The main body unit 3 includes a main body frame 5 includes a pair of sidewall portions 5a which are arranged so as to oppose to each other along an apparatus width direction (X direction) and a platen roller 6 mounted to the main body frame 5 (refer to FIG. 2).

The main body frame 5 has a box shape, and between the respective sidewall portions 5a, there is formed a paper guide 5b for guiding the recording paper P. (refer to FIG. 2). Then, the recording paper P is conveyed under a state in which a back surface of the paper is directed toward the paper guide 5b.

Further, at a corner portion on one end side in an apparatus depth direction (Y direction) of the sidewall portions 5a, there is formed an engagement recess portion 10 to which a lever member 22 described later of the cover unit 4 is engaged (refer to FIG. 1 to FIG. 3). The engagement recess portion 10 includes a tilting surface 11 tilted from other end side in the depth direction toward the one end side along a height direction (Z direction) and a recess portion 12 which is carved deeply on one end side of the height direction of the tilting surface 11 toward the other end side in the depth direction. Note that, with the lever member 22 and the engagement recess portion 10, a lock mechanism for locking the main body unit 3 and the cover unit 4 is constructed.

On the other hand, on the other end side in the depth direction of the both sidewall portions 5a, there is formed a through-hole 13 penetrating the sidewall portions 5a along the width direction, and a rotation shaft 15 rotatably supporting the cover unit 4 is inserted into the through-hole 13.

To the respective sidewall portions 5a, the platen roller 6 is rotatably supported. The platen roller 6 is constructed by integrating a roller main body 6b made of rubber or the like with a roller shaft 6a extending along the width direction. At each of the both end sides in the axial direction (X direction) of the roller shaft 6a, there is mounted a bearing 18 to the sidewall portions 5a, and as the bearing 18 is retained by the sidewall portions 5a, the platen roller 13 is rotatably supported about a center axis O1. Note that, on the one end side in the axial direction of the roller shaft 6a, a gear (not shown), which meshes with a gear train mechanism (not shown), is fixed. Further, there is constructed so that, through the gear train mechanism, a drive force from drive means (not shown) such as a motor, which is provided to the main body frame 5, is transmitted to the gear so as to be able to rotate the platen roller 6. The roller main body 6b is disposed so that a part of a peripheral direction projects from the paper guide 5b of the main body frame 5 toward the other end side in the height direction. Therefore, it is constructed so that, when the cover unit 4 is mounted thereto, the outer peripheral surface is brought into contact with respect to a thermal head 19 described later under a state in which the recording paper P pulled out from the roll paper is sandwiched therebetween.

The cover unit 4 includes a cover frame (detachable frame) 21 rotatably supported with respect to the main body frame 5, the lever member 22 which is engaged with the main body unit 3 in association with the mounting operation of the cover unit 4, the thermal head 19 provided to the cover frame 21, including a large number of heating elements 14 (refer to FIG. 5) on the head surface 19a, [symbol] the head support member 23 (refer to FIG. 4 and FIG. 5) supporting the thermal head 19, and an elastic member (first urging means) 24, such as a coil spring, which urges the head support member 23 so as to press against the platen roller 6.

The cover frame 21 is, for example, a C-shaped plate, which is formed by bending the both sides in the width direction toward the one end side in the height direction. On the other end side in the depth direction of the sidewall portion 21a of the cover frame 21, there is formed a through-hole (not shown) penetrating in the width direction, and the above-mentioned rotation shaft 15 is inserted into the through-hole. With this structure, the cover unit 4 is rotatably supported to the main body unit 3 about the rotation shaft 15.

The lever member 22 is a C-shaped plate, which is formed by bending the both sides in the width direction toward the other end sides in the depth direction, and is disposed so as to cover the main body frame 5 from the one end side in the depth direction. At positions on respective sidewall portions 21a and 22a superimposing when viewed from the width direction, a shaft 30 is inserted into the cover frame 21 and the lever member 22, and the lever member 22 is rotatably supported with respect to the cover frame 21 about the shaft 30. On the other end side in the depth direction of the sidewall portion 22a of the lever member 22, there is formed an engage convex portion 31 which is engaged with the engagement recess portion 10 of the main body frame 5. The engage convex portion 31 includes a tilting surface 32 tilted from the other end side in the height direction to the one end side toward the other end side in the depth direction, and a convex portion 33 which projects on the one end side in the height direction of the tilting surface 32 toward the other end side in the depth direction. Then, it is constructed such that the convex portion 33 of the lever member 22 fits into a recess portion 12 of the main body frame 5, and hence the main body unit 3 and the cover unit 4 are engaged with each other. Note that, although not illustrated, the elastic member is interposed between the lever member 22 and the cover frame 21, and the engage convex portion 31 urges the lever member 22 toward a fitting direction into the engagement recess portion 10.

A wall portion 22b on the one end side in the depth direction of the lever member 22 extends until a position at which the wall portion 22b overlaps with a wall portion 5c on the one end side in the depth direction of the main body frame 5, and the one end side of the height direction constructs an operation portion 34 which is bent about 90 degrees toward the one end side in the depth direction. Then, it is constructed such that, by pulling up the operation portion 34 toward the one end side in the height direction, the lever member 22 rotates about the shaft 30, to thereby release the engagement of the engage convex portion 31. Note that, at the wall portion 22b of the lever member 22, there is formed a delivery port 22c for delivering the recording paper P conveyed along the paper guide 5b. The delivery port 22c has a slit shape extending along the width direction of the wall portion 22b, and is opened toward a user (clerk) side at the cash resister, for example.

Here, as illustrated in FIG. 4 and FIG. 5, the head support member 23 includes a plate-shape support member main body 37 having a width direction as a longitudinal direction and a positioning mechanism 38 which performs the positioning of the thermal head 19 with respect to the platen roller 6 at the mounting of the cover unit 4.

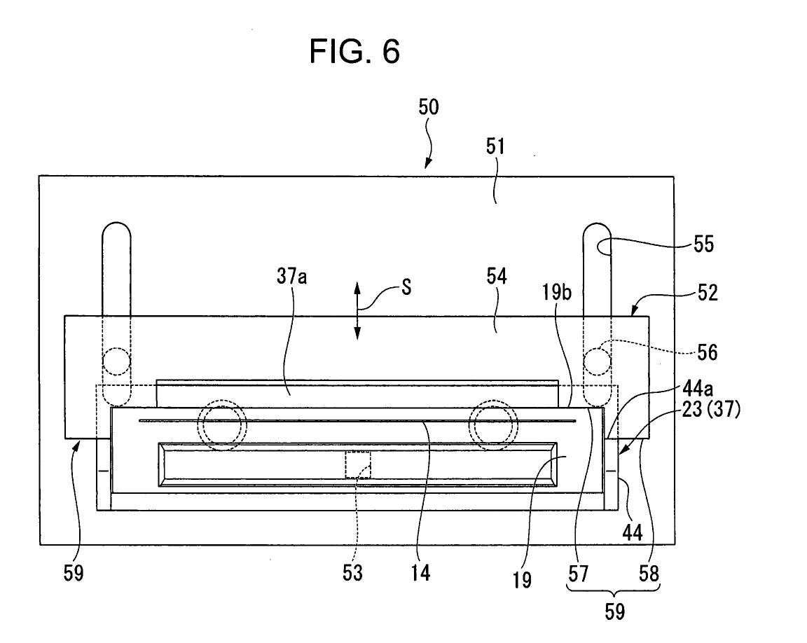

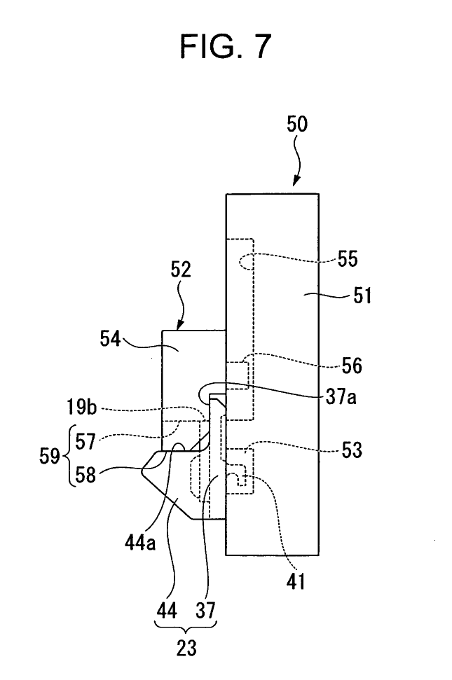

The surface of the support member main body 37 functions as a pasting surface 37a, onto the surface of which (surface on one end side in the height direction) the above-mentioned thermal head 11 is pasted and fixed. The thermal head 19 has a rectangular shape, in which the width direction is a longitudinal direction, in a planar view (viewed from height direction) between the sidewall portions 21a of the cover frame 21, and a large number of the heating elements 14 are arrayed on the head surface 19a in parallel with the axial direction of the platen roller 13 and in a line. Note that, the head surface 19a is an opposing surface to a printing surface of the recording paper P, and it is constructed such that, when the cover unit 4 is mounted, the recording paper P may be sandwiched between the head surface 19a and the outer peripheral surface of a roller main body 13c of the platen roller 13. In other words, under a state in which the printing surface of the recording paper P is directed toward the other end side in the height direction, and information printed on the printing surface is directed toward a normal direction relative to a guest, the recording paper P is delivered. Therefore, the clerk may hand over the recording paper P to the guest without changing the direction of the recording paper P, thereby being capable of performing a cash register operation smoothly. Note that, it is constructed so that the thermal head 19 is pasted on a predetermined position of the pasting surface 37a of the support member main body 37 with a below-mentioned pasting jig 50 (refer to FIG. 6 and FIG. 7). Further, on the other end side in the depth direction of both sides in the width direction of the support member main body 37, there is formed a mounting piece 39 extending toward the one end side in the height direction (refer to FIG. 5), and in the mounting piece 39, there is formed a through-hole (guide hole) 40 penetrating along the width direction.

The through-hole 40 is formed into an oblong shape extending so that, when the cover unit 4 is mounted, the long diameter direction coincides with the depth direction (short hand direction of the head support member 37). Into the through-hole 40, the above-mentioned rotation shaft 15 is inserted. Accordingly, similar to the cover frame 21, the head support member 23 is rotatably supported about a center axis of the rotation shaft 15 as a rotation center O2, and is also constructed so that the head support member 23 is slidably movable along the oblong through-hole 40 on the rotation shaft 15 in the depth direction.

Between the head support member 23 and the cover frame 21, the elastic member 24 is interposed, and the cover frame 21 and the head support member 23 are urged by the elastic member in a direction so as to repel with each other. In other words, the elastic member 24 is constructed so that the head support member 23 is always urged toward the platen roller 6 side.

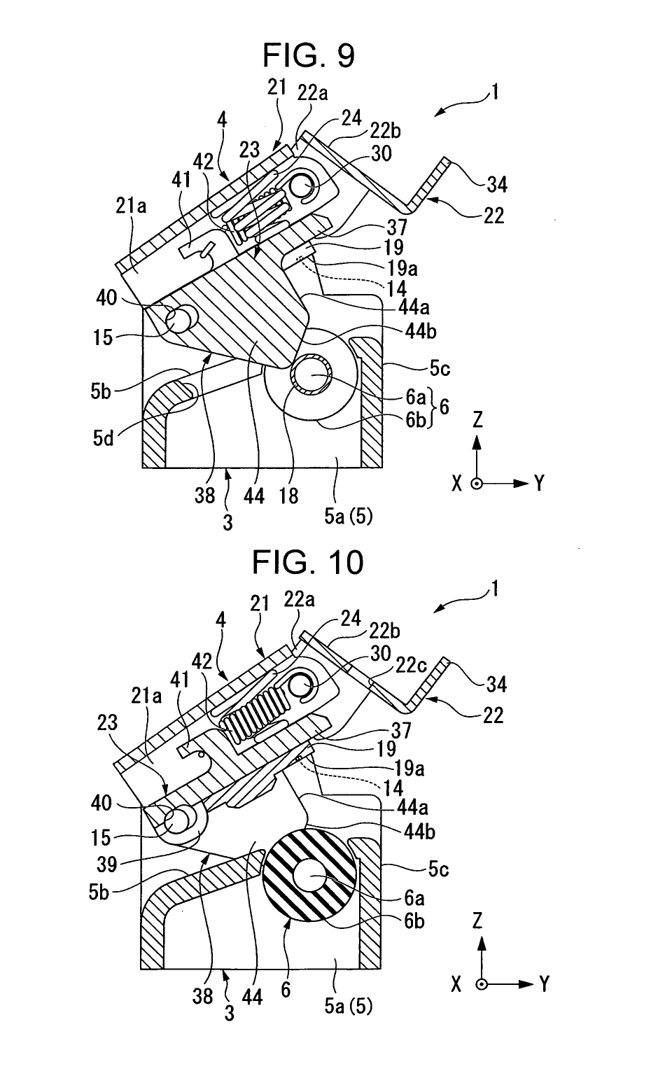

Further, at a center portion of a surface opposite to the pasting surface 37a of the head support member 23, a hook portion 41 is formed upright projecting in the height direction. The hook portion 41 has an L-shape when viewed from a side (viewed from the width direction), and between the hook portion 41 and the shaft 30, the elastic member (second urging means) 42 formed of a coil spring, or the like, is interposed. The one end of the elastic member 42 is coupled to the shaft 30, whereas the other end is coupled to the hook portion 41, thereby urging the head support member 23 on the one end side in the depth direction. Accordingly, when the cover frame 21 is mounted, as illustrated in FIG. 4 and FIG. 5, the rotation shaft 15 is disposed at the center position within the through-hole 40, whereas when the cover frame 21 is not mounted, as illustrated in FIG. 9, the rotation shaft 15 is disposed at one end position within the through-hole 40.

On both sides in the width direction of the support member main body 37, there are formed regulating plates (regulating portions) 44 extending toward a direction at which the platen roller 6 is disposed (on one end side in the height direction). The regulating plates 44 are, for example, plate-like members, and at each of the end surfaces thereof (end surface on one end side in the depth direction), which are brought into contact with the outer peripheral surface of the bearing 18 of the platen roller 6 when the platen roller 6 is mounted, the regulating surface 44a formed of a flat surface is formed (refer to FIG. 4). The normal direction of the regulating surface 44a coincides with a short hand direction (depth direction) of the thermal head 19. In other words, the surface direction of the regulating surface 44a is provided so as to be orthogonal to the short hand direction of the thermal head 19. The regulating surface 44a functions as a positioning reference surface at a time of pasting the thermal head 19 onto the head support member 23. In addition, when the platen roller 6 is mounted, the outer peripheral surface of the bearing 18 of the platen roller 6 is abutted on the regulating surface 44a so that the heating elements 14 of the thermal head 19 are positioned at predetermined positions with respect to the platen roller 6.

Further, a leading end of the regulating plate 44 is formed, for example, into a taper shape which is tapered toward the one end side in the height direction, and the end surface on the one end side in the depth direction is constructed so as to be contactable with the bearing 18 of the platen roller 6. Accordingly, the leading end of the regulating plate 44 constitutes the guide hole 44b which guides the movement of the head support member 23 so that the regulating surface 44a abuts on the bearing 18 in association with the mounting operation of the cover unit 4. Further, in the mounting state of the cover unit 4, the one end side in the height direction of the regulating plate 44 is adapted to enter into a relief grove 5d formed in the paper guide 5b (refer to FIG. 4).

Further, the positioning mechanism 38 of this embodiment is constructed of the through-hole 40, the regulating plate 44, and the elastic member 42, which are described above.

(Thermal Head Pasting Method)

Next, description is made of a method of pasting a thermal head 19 onto the above-mentioned head support member 23.

As described above, the thermal head 19 is pasted onto the head support member 23 using the pasting jig 50. Therefore, in the following description, the structure of the pasting jig 50 is first described.

(Pasting Jig)

FIG. 6 is a plan view of the pasting jig, and FIG. 7 is a side view thereof.

As illustrated in FIG. 6 and FIG. 7, the pasting jig 50 includes: a rectangular shape setting portion 51 in a planar view; and a holding member 52 which is movable along the short hand direction of the support member main body 37 with respect to the setting portion 51 (refer to arrow S of FIG. 6).

The surface portion of the setting portion 51 functions as a setting surface on which the head support member 23 is set, and on one side of a surface portion of the setting portion 51, there are formed a recess portion 53 for escaping a hook portion 41 of the support member main body 37 along a thickness direction of the setting portion 51. Besides, on another side which is opposite to the one side in which the recess portion is formed in the setting portion 51, there are formed oblong-shape guide grooves 55 extending along the height direction (short hand direction) of the setting portion 51. Note that, the guide grooves 55 are formed at two portions across the width direction (longitudinal direction) of the setting portion 51.

The holding member 52 includes a base portion 54 extending along the width direction of the setting portion 51, and at an end surface which faces on the setting portion 51 of the base portion 54, there are formed guide bars 56 extending within the above-mentioned respective guide grooves so as to face the guide grooves. The guide bars 56 are constructed to be movable within the guide grooves 55, whereby the holding member 52 is configured to be movable on the surface portion of the setting portion 51 along the height direction of the setting portion 5.

At both end portions in the width direction of the base portion 54, under a state of leaving spaces between themselves and the setting portion 51, positioning portions 59 extending toward one side of the setting portion 51 are formed at two positions in the width direction of the base portion 54 from the base portion 54 along the surface of the setting portion 51. The respective positioning portions 59 conduct, when the thermal head 19 is to be pasted, the positioning of the thermal head 19 with respect to the regulating surface 44a of the head support member 23. Specifically describing, the positioning portions 59 are each formed into a step-wise shape projecting step by step toward the above-mentioned one side direction as approaching toward the both end sides in the width direction of the base portion 54, and are each constructed of a head positioning portion 57 formed inside and a regulating plate positioning portion 58 formed outside.

The regulating plate positioning portion 58 is a flat surface extending along the width direction of the base portion 54, on which, at the time of pasting operation of the thermal head 19, the regulating surface 44a of the regulating plate 44 is abutted. Note that, the positioning of the head support member 12 with respect to the setting portion 51 is carried out through fixing of the hook portion 41 inside the recess portion 53.

On the other hands, the head positioning portion 57 is also a flat surface extending in the width direction of the base portion 54, and toward the one side of the setting portion 51, the head positioning portion 57 and the regulating plate positioning portion 58 are disposed in parallel in the stated order in a step-wise shape. The head positioning portion 57 allows, at the time of pasting operation of the thermal head 19, one end surface 19b of the thermal head 19 in the height direction to be abutted thereonto, to thereby conduct the positioning of the thermal head 19 on the pasting surface 37a of the support member main body 37. In this case, the regulating plate positioning portion 58 is abutted on the regulating surface 44a, to thereby determine the pasting position of the thermal head 19 with respect to the regulating surface 44a. With this structure, the thermal head 19 may be pasted on the pasting surface 37a of the support member main body 37 by the regulating surface 44a as a reference.

Next, description is made of a pasting procedure for pasting the thermal head 19 onto the pasting surface 37a of the head support member 23 using the above-mentioned pasting jig 50.

First, under a state in which the holding member 52 is moved toward the above-mentioned the other side, the head support member 23 is set to the setting portion 51.

Subsequently, the holding member 52 is moved toward the one side direction of the setting portion 51 along the guide grooves 55, and the regulating plate positioning portion 58 is abutted on the regulating surface 44a of the regulating plate 44. With this operation, the relative position of the head positioning portion 57 with respect to the regulating surface 44a of the head support member 12 is fixed.

Then, the thermal head 19 is fixed onto the pasting surface 37a of the head support member 23 via an adhesive. Specifically, under a state in which the end surface 19b of the thermal head 19 is abutted on the head positioning portion 57, the thermal head 19 is pasted on the pasting surface 37a of the support member main body 37. With this operation, the heating elements 14 of the thermal head 19 may be arranged with respect to the regulating surface 44a of the support member main body 37 at predetermined positions with high precision.

(Action)

Next, description is made of an action of the positioning mechanism according to this embodiment.

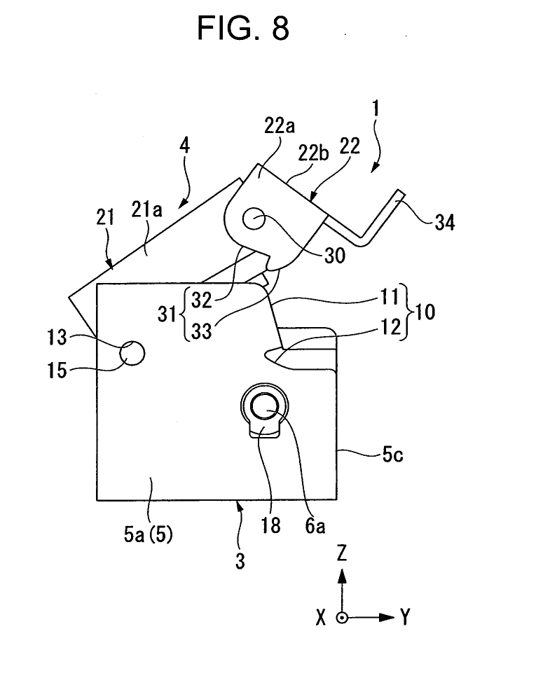

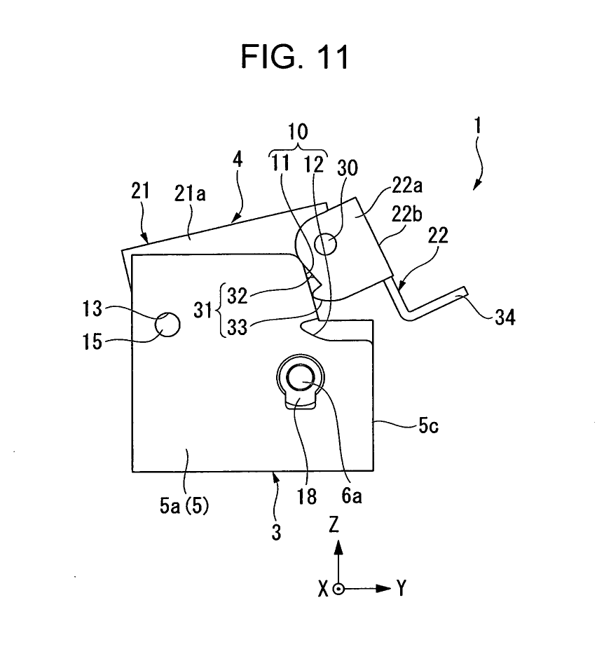

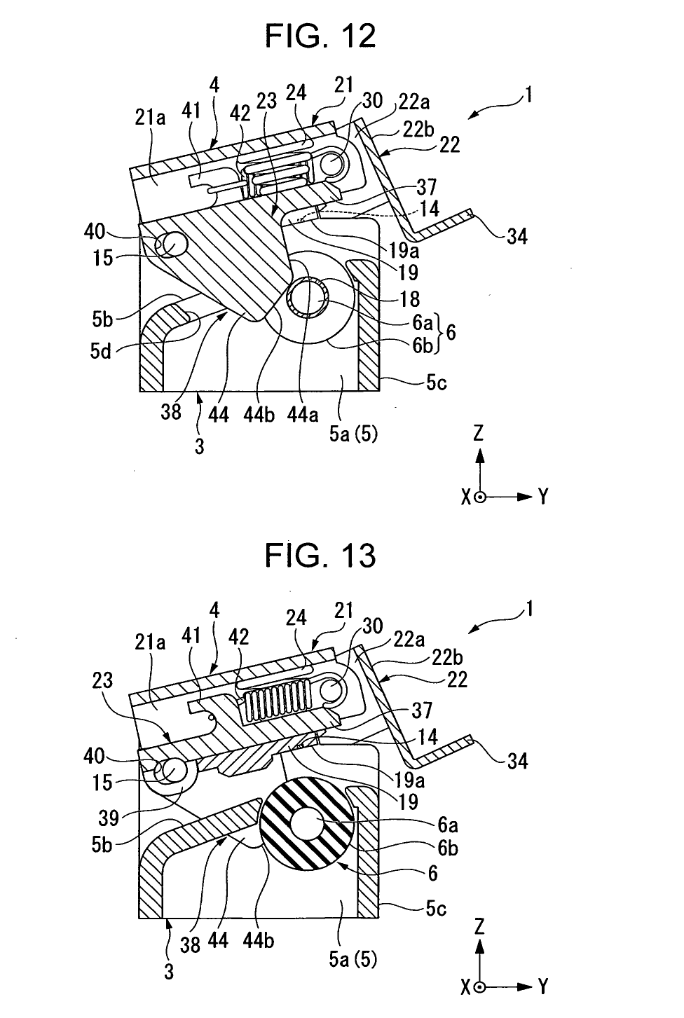

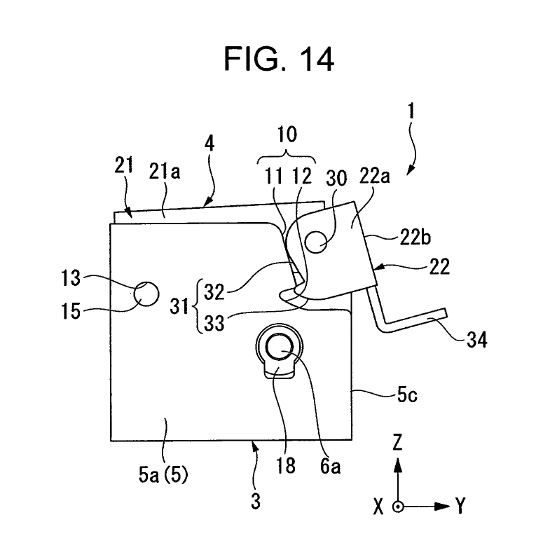

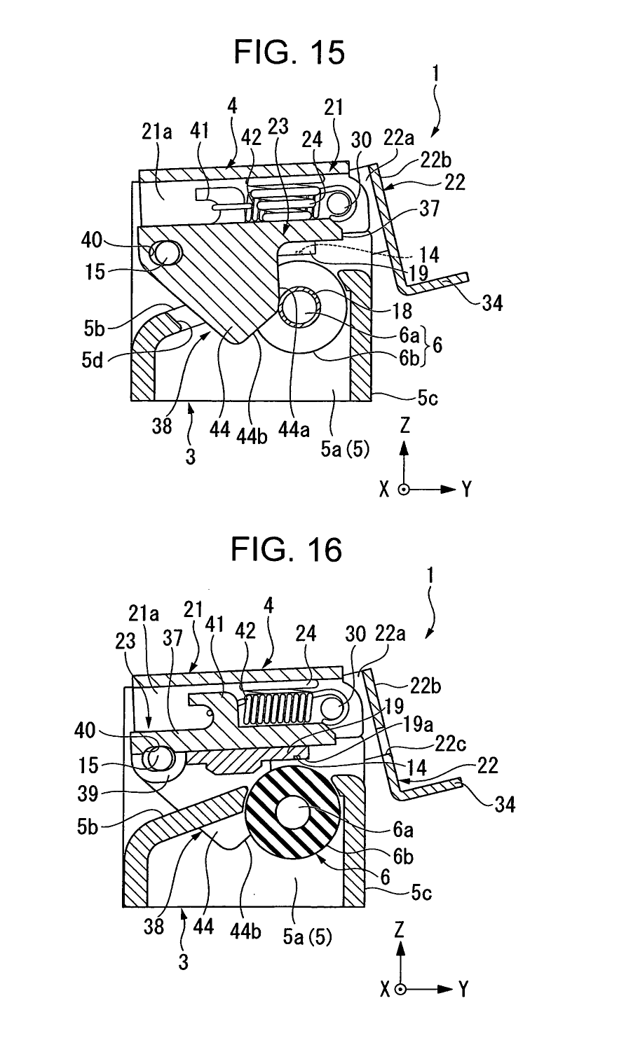

FIG. 8 to FIG. 16 are diagrams illustrating operations at the time of mounting operation of the cover unit, and FIG. 8, FIG. 11, and FIG. 14 correspond to FIG. 3, FIG. 9, FIG. 12, and FIG. 15 correspond to FIG. 4, and FIG. 10, FIG. 13, and FIG. 16 correspond to FIG. 5, respectively.

As illustrated in FIG. 8 to FIG. 10, when the mounting operation of the cover unit 4 is carried out by depressing the cover frame 21, first, the leading end of the regulating plate 44 of the head support member 23 abuts on the outer peripheral surface of the bearing 18 of the platen roller 6. Note that, as the head support member 23 is urged by the elastic member 42 toward the one end side in the depth direction, when the cover unit 4 is not mounted, the shaft 15 is disposed at the one end portion within the through-hole 40.

When the cover frame 21 is further depressed, as illustrated in FIG. 11 to FIG. 13, the guide portion 44b of the regulating plate 44 slides on the outer peripheral surface of the bearing 18, and the head support member 23 moves on the rotation shaft 15 toward the other end side in the depth direction along the through-hole 40. At the same time, the convex portion 33 of the lever member 22 abuts on the tilting surface 11 of the main body frame 5, and then the convex portion 33 slides on the tilting surface 11 of the main body frame 5. Note that, at the time of mounting the cover unit 4, the regulating plate 44 is free from being contact with the paper guide 5b, and enters into the relief groove 5d of the main body frame 5. Therefore, the mounting operation of the cover unit 4 is free from being interrupted by the regulating plate 44.

After that, as illustrated in FIG. 14 to FIG. 16, the outer peripheral surface of the bearing 18 abuts on the regulating surface 44a over the guide portion 44b. At this time, the head support member 23 is urged by the elastic member 42 toward the one end side in the depth direction, and hence after the contacting of the bearing 18 of the platen roller 6 with the regulating surface 44a, without the regulating surface 44a being spaced apart from the bearing 18, the mounting operation of the latter stage may be carried out while maintaining the contacting state.

Then, if the mounting operation of the cover unit 4 is further advanced, the outer peripheral surface of the roller main body 6b abuts on the thermal head 19. At this time, the thermal head 19 is urged by the elastic member 24 through the intermediation of the head support member 23, and hence the head surface 19a of the thermal head 19 is brought into press-contact with the outer peripheral surface of the roller main body 6b.

Like this, the head surface 19a of the thermal head 19 is brought into press-contact with the roller main body 6b of the platen roller 6 by the elastic member 24, and also the regulating surface 44a abuts on the bearing 18 of the platen roller 6 by the elastic member 42. As a result, the relative position of the thermal head 19 with respect to the platen roller 6 is regulated. At this time, the regulating surface 44a is a flat surface, which is orthogonal to the short hand direction of the thermal head 19, and also the thermal head 19 is positioned and fixed to the regulating surface 44a. As a result, the heating elements 14 of the thermal head 19 may be positively positioned with respect to the platen roller 6. Then, the thermal head 19 is positioned and fixed with respect to the regulating surface 44a at a position at which a satisfactory printing quality may be obtained when the bearing 18 of the platen roller 6 abuts on the regulating plate 44. As a result, the platen roller 6 and the heating elements 14 of the thermal head 19 may be positively positioned at the position at which a satisfactory printing quality may be obtained, namely within the allowable range L1 of the heating elements. Further, as described above, the head support member 23 is urged by the elastic member 42 toward the one end side in the depth direction. Accordingly, under a state in which the bearing 18 of the platen roller 6 and the regulating surface 44a are brought into contact with each other, and still further, while maintaining the positional relationship between the outer peripheral surface of the roller main body 6a and the heating elements 14, which is the above-mentioned positional relationship by which the satisfactory printing quality may be obtained, the subsequent mounting operation may be carried out.

On the other hand, after the abutment of the platen roller 6 and the regulating surface 44a, the convex portion 33 of the lever member 22 overrides the tilting surface 11 of the main body frame 5. As a result, the lever member 22 rotates, and the convex portion 33 enters into the recess portion 12 of the main body frame 5. With this operation, under a state in which the recording paper P is sandwiched between the platen roller 6 and the thermal head 19, the cover unit 4 may be mounted to the main body unit 3.

By the way, even if the installation position of the platen roller 6 with respect to the main body unit 3, the installation position of the thermal head 19 in the cover unit 4, and the relative positions of the heating elements 14 with respect to the platen roller 6, or the like, when the cover unit 4 is mounted to the main body unit 3, are slightly displaced due to manufacturing tolerance, or the like from the positions determined at a designing stage, and even if the tilting angle of the head support member 23 is changed from an ideal position due to generation of an error in the thickness direction of the pasting surface 37a in the head support member 23, different from the conventional one, the positional relationship between the platen roller 6 and the heating elements 14 may be kept unchanged from the above-mentioned positional relationship.

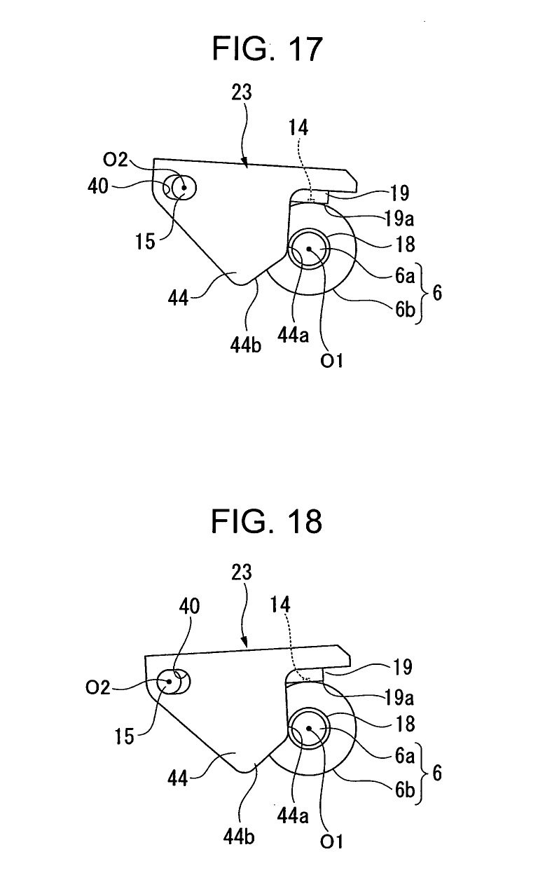

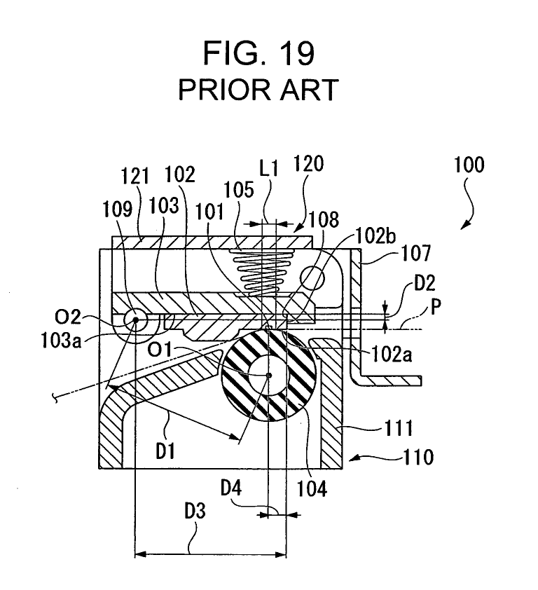

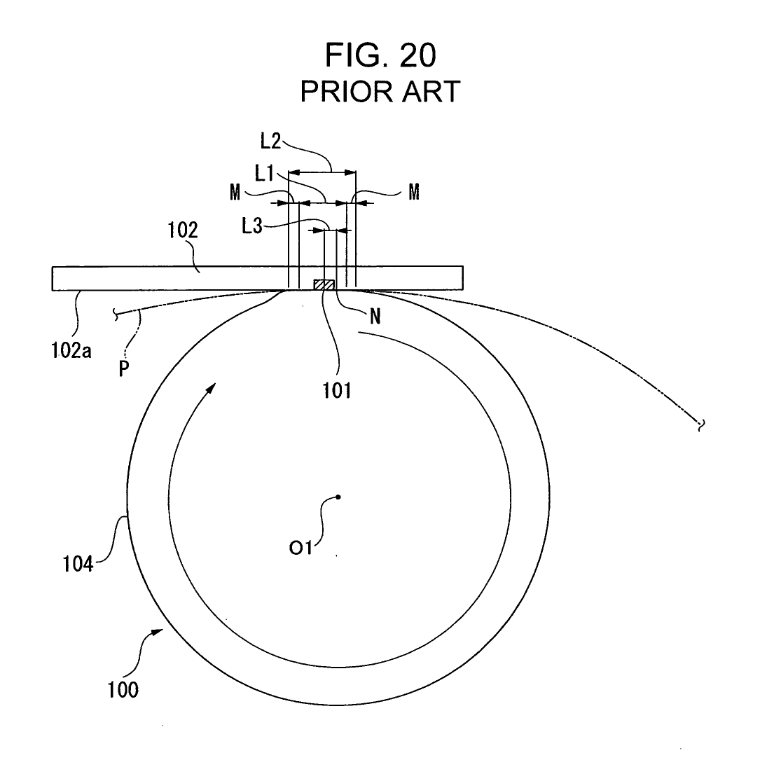

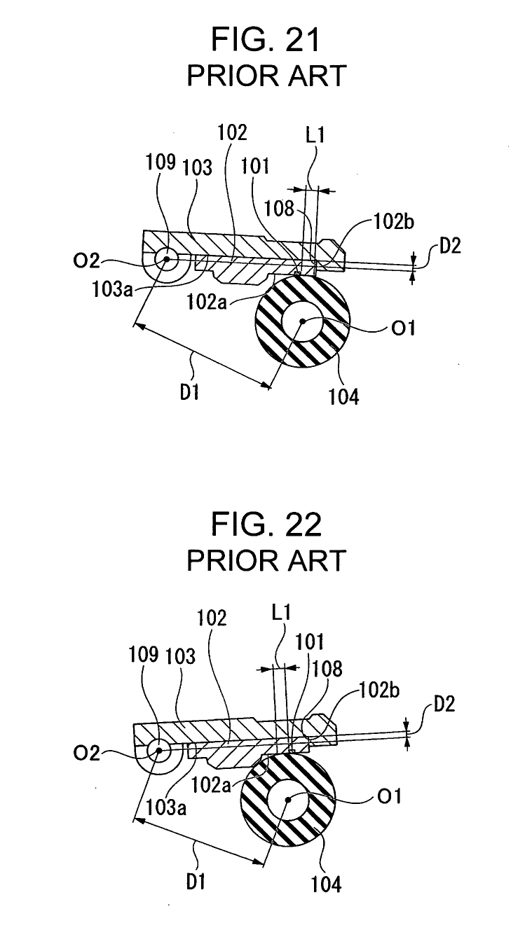

For example, in a case where the distance D1 of the above-mentioned condition (1) or the distance D2 of the condition (2) (refer to FIG. 5 in any case) is shifted a little from a position determined at the designing stage due to manufacturing tolerance, or the like, and the head support member 19 is tilted forward, the regulating surface 44a tilts forward by the same amount as the head support member 23 tilted forward. However, in this embodiment, as illustrated in FIG. 17, at the time when the bearing 18 of the platen roller 6 abuts on the regulating portion 44a, the head surface 19a of the thermal head 19 is brought into pressure contact with the platen roller 6 by the elastic members 24, and also the regulating surface 44a abuts on the platen roller 6 by the elastic member 24. Therefore, the head support member 23 conducts a slide movement corresponding to the tilting amount of the head support member 23 using the through-hole 40 so that the regulating surface 44a and the head surface 19a of the thermal head 19 conduct slide movements along the outer peripheral surface of the platen roller 6 and the outer peripheral surface of the bearing 18. As a result, the platen roller 6 and the heating elements 14 are positioned at positions at which a satisfactory printing quality is obtained, namely, positioned so as to fall within the allowable range L1 of the heating element. Further, for example, as illustrated in FIG. 18, the case where the head support member 23 is tilted backward is also the same.

Like this, in this embodiment, it is configured so that the relative position between the platen roller 6 and the thermal head 19 is determined with the regulating surface 44a being reference. As a result, the influences of position displacement factors such as the conditions (1) and (2), for example, which are conventionally identified as problems may be eliminated. Therefore, the positioning precision of the thermal head 19 with respect to the platen roller 6 is enhanced, thereby being capable of positively positioning the heating elements 14 within a predetermined allowable range L1 of the heating element. Owing to this, the heating element 14 may be disposed within the allowable range L1 of the heating element, which copes with all of the plurality of kinds of the recording paper P having different thicknesses and stiffnesses, thereby being capable of printing by the same apparatus to all the recording paper P with a satisfactory printing quality.

Further, the guide portion 44b, which guides the regulating surface 44a so as to abut on the platen roller 6, is formed in the head support member 23, and hence, the head support member 23 may be moved smoothly along the through-hole 35 in the mounting operation. As a result, when the regulating surface 44a and the platen roller 6 are abutted on each other, the mounting operation of the cover unit 4 is free from being interrupted, thereby being capable of quickly mounting the cover unit 4 to the main body unit 3.

In addition, the through-hole 40, which allows the head support member 23 to be movable, is formed into a long hole, and hence the head support member 23 conducts a slide movement with respect to the rotation shaft 15 along the depth direction. With this structure, the head support member 23 conducts the slide movement along the depth direction, there is no need to provide a separate moving mechanism. Owing to this, the structure may be simplified, and also the reduction of the manufacturing cost may be achieved.

It should be noted that the technical scope of the present invention is not limited to the above-mentioned embodiments, and may be variously modified as long as it does not depart from the split of the present invention.

Further, in this embodiment, description is made of a case in which the head-open type thermal printer 1 is employed for a cash resister, or the like, but is not limited thereto. There may be employed for, for example, a fee adjustment machine at a parking place or a fee adjustment machine of an oil feeder at a self-service gasoline station, a ticket dispenser, a portable information terminal, or the like to be installed in various kinds of food and drink stores.

Further, in the above-mentioned embodiment, description is made of a case in which the coil spring is used as the second urging means. However, the present invention is not limited thereto, and a plate spring, or the like may be used.

In addition, in the above-mentioned embodiment, description is made of the structure in which the rotation center of the head support member 23 with respect to the main body frame 5 and the rotation center of the cover frame 21 with respect to the main body frame 5 coincide with the center axis of the rotation shaft 15, but is not limited thereto. There may be employed a structure in which the rotation center of the head support member 23 with respect to the main body frame 5 and the rotation center of the cover frame 21 with respect to the main body frame 5 may be set separately.

What is claimed is:

1. A thermal printer, comprising:
a main body unit having a platen roller for performing paper feeding of recording paper;
a detachable unit detachably provided with respect to the main body unit; and
a lock mechanism for locking the main body unit and the detachable unit;
the detachable unit comprising:
a detachable frame;
a thermal head in which heating elements which perform printing on the recording paper are arranged on a head surface which is disposed in parallel with an axial direction of the platen roller when the detachable unit is mounted;
a head support member onto which the thermal head is pasted and fixed, and is rotatably supported about a rotation shaft provided to the detachable frame;
first urging means for urging the thermal head so as to be brought into pressure contact with the platen roller through intermediation of the head support member; and
a positioning mechanism which performs positioning of the thermal head with respect to the platen roller,
wherein the positioning mechanism comprises:
a guide hole which allows the head support member to be movable with respect to the detachable frame along a first direction which is orthogonal to an axial direction of the platen roller within a plane which is parallel to the head surface of the thermal head;
a regulating portion, which is formed in the head support member, serving as a positioning reference portion at a time of positioning and fixing the thermal head to the head support member, and positioning, when the platen roller is mounted, positions of the heating elements with respect to the platen roller through abutment of the platen roller to the regulating portion;
second urging means for urging the head support member along the first direction so that the regulating portion is abutted to the platen roller; and
a guide portion, which is formed in the head support member, for guiding the head support member by moving the head support member along the guide hole in association with a mounting operation of the detachable unit while sliding with the platen roller so that the regulating portion abuts the platen roller, and
wherein the regulating portion is formed in a flat surface, and a normal line direction of the flat surface coincides with the first direction.

2. A thermal printer according to claim 1,
wherein the guide hole is a long hole, which is formed in the head support member, having a length direction as the first direction, and
wherein the rotation shaft is inserted and passed through the long hole.
